(19) United States
(12) Patent Application Publication
(10) Pub. No.: US 2014/0302385 A1
(43) Pub. Date: Oct. 9, 2014

(54) ELECTRODE FOR LITHIUM SECONDARY BATTERY, LITHIUM SECONDARY BATTERY USING THE SAME, AND METHOD OF FABRICATING THE SAME

(71) Applicant: POSTECH ACADEMY-INDUSTRY FOUNDATION, Gyeongbuk (KR)

(72) Inventors: Hee Cheul Choi, Gyeongbuk (KR); Hyungki Kim, Gyeongbuk (KR)

(21) Appl. No.: 13/919,786

(22) Filed: Jun. 17, 2013

(30) Foreign Application Priority Data
Apr. 5, 2013 (KR) 10-2013-0037314

(51) Int. Cl. H01M 4/36; H01M 4/04

(52) U.S. Cl. CPC H01M 4/366; H01M 4/0428
USPC 429/188; 429/231.8; 427/122; 427/117; 427/105

(57) ABSTRACT

A negative electrode for a lithium (Li) secondary battery, a lithium secondary battery using the same, and a method of fabricating the same are provided. The negative electrode for the lithium secondary battery includes a germanium (Ge) structure and a graphene layer directly disposed on a surface of the germanium structure, and the graphene layer is grown on the surface of the germanium structure using a catalyst-free growth process. Accordingly, by directly disposing the graphene layer on the surface of the germanium structure, volume expansion of the germanium structure may be minimized during cycles of an alloying/dealloying reaction with lithium and high electronic conductivity can maintained during long cycles.

### CLAIM FOR PRIORITY

This application claims priority to Korean Patent Application No. 10-2013-0037314 filed on Apr. 05, 2013 in the Korean Intellectual Property Office (KIPO), the entire contents of which are hereby incorporated by reference.

### BACKGROUND

1. Technical Field

Example embodiments of the present invention relate in general to (the field of) a negative electrode for a lithium secondary battery, a lithium secondary battery using the same, and a method of fabricating the same, and more specifically, to a negative electrode for a lithium secondary battery, which may minimize volume expansion of a germanium structure during cycles of an alloying/dealloying reaction with lithium (Li).

2. Related Art

A lithium (Li) secondary battery has widely been used for portable electronic products, such as portable phones and laptop computers. It is expected that the demand for lithium secondary batteries will rapidly increase due to continuous domestic and foreign developments of electronic industries. With an increase in the demand for lithium secondary batteries, lithium secondary batteries of higher performance than conventional batteries have been required.

In general, a carbon-based material (e.g., carbon (C) or black lead) having a low electric potential may be mainly used as a negative active electrode of a lithium secondary battery. However, since the carbon-based material has a theoretical capacity of only about 372 mAh/g, it is necessary to develop a new negative electrode active material to obtain high-capacity batteries.

Accordingly, there have been studies on semiconductor or metal materials (e.g., silicon(Si), germanium(Ge), or tin(Sn)) capable of forming alloys with lithium, as new-generation negative electrode materials.

Among the semiconductor or metal materials, research has mainly been conducted on silicon nanowires (Si NWs) and silicon nanoparticles (Si NPs) because of high theoretical capacities thereof.

Meanwhile, although germanium has a lower capacity than silicon, germanium nanowires have attracted attention because the germanium nanowires have a higher electrical conductivity and a higher lithium ion diffusion rate than silicon nanowires. Thus, it may be inferred that germanium is more appropriate for a negative electrode having a higher rate capability than silicon.

However, when a germanium nanowire is adopted as a negative electrode of a lithium ion battery, the volume of the germanium nanowire may expand about 370% during a charging/discharging cycle of an alloying/dealloying reaction with lithium.

Due to the volume expansion of the germanium nanowire, deformation of an electrode structure due to a current collector and destruction of a negative electrode active material may occur, thereby degrading the characteristics of the charging/discharging cycle.

### SUMMARY

Accordingly, example embodiments of the present invention are provided to substantially obviate one or more problems due to limitations and disadvantages of the related art.

Example embodiments of the present invention provide a negative electrode for a lithium secondary battery, which may minimize volume expansion of a germanium structure during charging/discharging cycles of alloying/dealloying reactions with lithium (Li).

Example embodiments of the present invention also provide a negative electrode for a lithium secondary battery, in which lithium ions may easily diffuse into and react with a germanium structure.

Furthermore, example embodiments of the present invention provide a lithium secondary battery using a negative electrode for a lithium secondary battery, and a method of fabricating the same.

In some example embodiments, a negative electrode for a lithium secondary battery includes a germanium (Ge) structure, and a graphene layer directly disposed on a surface of the germanium structure. The graphene layer is grown on the surface of the germanium structure using a catalyst-free growth process.

In other example embodiments, a negative electrode for a lithium secondary battery includes a germanium structure, and a graphene layer directly disposed on a surface of the germanium structure. The number of graphene layers ranges from 1 to 6.

In still other example embodiments, a method of fabricating a negative electrode for a lithium secondary battery includes preparing a germanium structure, and directly growing a graphene layer on a surface of the germanium structure using a catalyst-free chemical vapor deposition (CVD) process.

In yet other example embodiments, a lithium secondary battery includes a positive electrode, a negative electrode including a germanium nanostructure and a graphene layer directly disposed on a surface of the germanium nanostructure, and a lithium-salt electrolyte interposed between the positive electrode and the negative electrode.

### BRIEF DESCRIPTION OF DRAWINGS

Example embodiments of the present invention will become more apparent by describing in detail example embodiments of the present invention with reference to the accompanying drawings, in which:

FIG. 1 is a schematic view of a germanium nanowire (Ge NW) having a surface on which a graphene layer is directly disposed, according to an example embodiment of the present invention;

FIGS. 2A and 2B are schematic views of process operations of a method of fabricating a negative electrode for a lithium (Li) secondary battery according to an example embodiment of the present invention;

FIGS. 3A through 3F are scanning electron microscope (SEM) and transmission electron microscopes (TEM) images of a germanium nanowire and a germanium nanowire having a surface on which a graphene layer is directly disposed, and a graph;

FIGS. 4A through 4C are graphs showing voltage profiles and cycling characteristics of a germanium nanowire having a surface on which graphene is directly disposed;

FIGS. 5A through 5C are graphs showing characteristics of a germanium nanowire and a germanium nanowire having a surface on which graphene is directly disposed; and

FIGS. 6A through 6C are TEM images of a germanium nanowire and a germanium nanowire having a surface on which graphene is directly disposed, after performing a charging/discharging cycle.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that when a layer, a region, or a substrate is referred to as being “on” another layer or substrate, it can be directly on the other layer or substrate or intervening layers may also be present.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

A negative electrode for a lithium (Li) secondary battery according to an example embodiment of the present invention will now be described.

The negative electrode for the lithium secondary battery may include a germanium (Ge) structure and a graphene layer 200.

The germanium structure may be a germanium nanowire (Ge NW), a germanium nanoparticle (Ge NP), a germanium nanotube (Ge NT), a germanium film, or a germanium substrate.

Hereinafter, an example case in which the germanium structure is a germanium nanowire will be described in detail.

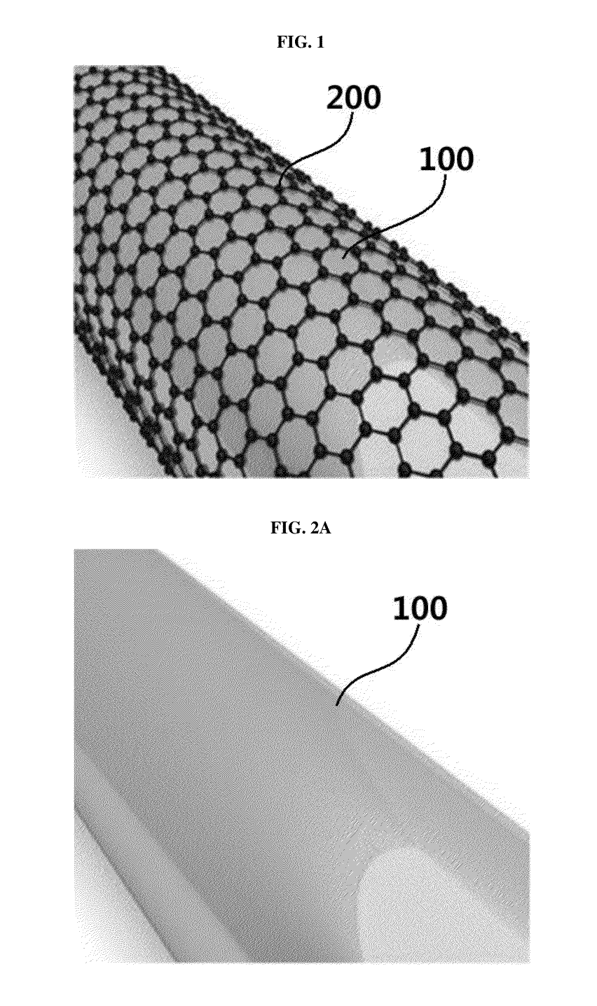

FIG. 1 is a schematic view of a germanium nanowire 100 having a surface on which a graphene layer 200 is directly disposed, according to an example embodiment of the present invention.

Referring to FIG. 1, the germanium nanowire 100 may serve as a negative electrode active material.

The graphene layer 200 may be directly disposed on the surface of the germanium nanowire 100. For example, the graphene layer 200 may be directly grown on the surface of the germanium nanowire 100 using a catalyst-free chemical vapor deposition (CVD) process so that the graphene layer 200 can be directly disposed on the surface of the germanium nanowire 100.

By directly disposing the graphene layer 200 on the surface of the germanium nanowire 100, the graphene layer 200 may mechanically fasten the germanium nanowire 100. Accordingly, the graphene layer 200 may minimize volume expansion of the germanium nanowire 100 during charging/discharging cycles of alloying/dealloying reactions with lithium (Li).

Furthermore, the entire negative electrode may ensure high electrical conductivity due to the graphene layer 200 having high electrical conductivity during a long cell cycle.

Meanwhile, the graphene layer 200 may be a single layer, or include a small number of layers.

As the number of layers included in the graphene layer 200 increases, the thickness of the graphene layer 200 may thicken. When the thickness of the graphene layer 200 is thick, it may be difficult for lithium ions to diffuse into the germanium nanowire 100 and input/output the lithium ions to/from the germanium nanowire 100.

Accordingly, the graphene layer 200 may be designed to include a single layer or a small number of layers so that the lithium ions can easily diffuse into the germanium nanowire 100 and react with the germanium nanowire 100.

For example, as the number of layers included in the graphene layer 200 increases, a diffusion of lithium ions may be greatly reduced. When the number of layers included in the graphene layer 200 is 6 or more, the diffusion of the lithium ions may be greatly reduced irrespective of the degree of defects and thus, it is preferred that the number of layers included in the graphene layer 200 range from 1 to 6.

In addition, the graphene layer 200 may include defects (not shown) having disconnection points so that lithium ions can easily diffuse into the germanium nanowire 100 and be input/output to/from the germanium nanowire 100.

For instance, the graphene layer 200 may include defects having disconnection points along a growth axis thereof.

When the graphene layer 200 is directly grown on the surface of the germanium nanowire 100 using a catalyst-free CVD process, a defect level may be determined by controlling a growth temperature of the graphene layer 200.

According to the present invention, by directly disposing the graphene layer 200 on the surface of the germanium structure, volume expansion of the germanium structure may be minimized during charging/discharging cycles of alloying/dealloying reactions with lithium.

Furthermore, the graphene layer 200 may include a single layer or a small number of layers and include an appropriate amount of defects so that lithium ions can easily diffuse into the germanium structure, be input to/output from the germanium structure, and react with the germanium structure.

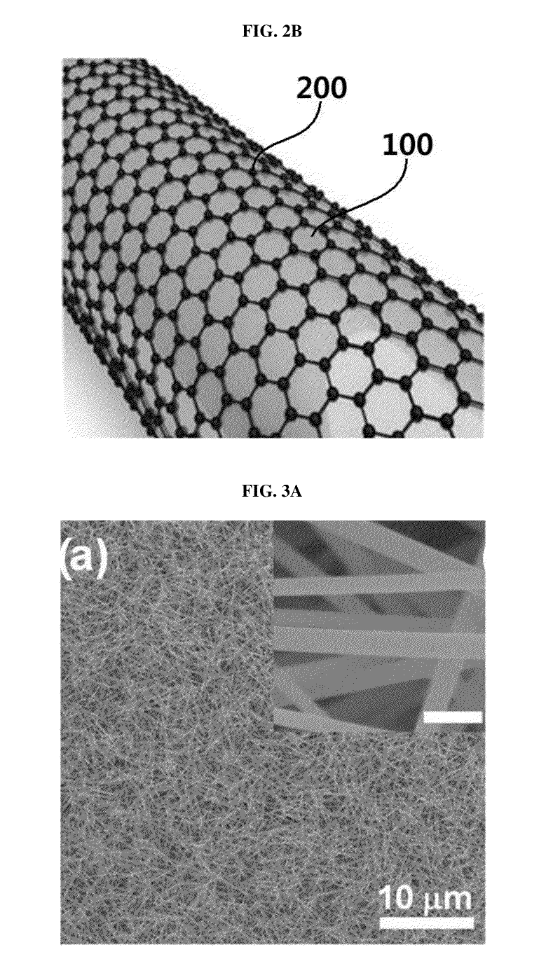

FIGS. 2A and 2B are schematic views of process operations of a method of fabricating a negative electrode for a lithium secondary battery according to an example embodiment of the present invention.

Referring to FIG. 2A, a germanium (Ge) structure may be initially prepared. The germanium structure may be a germanium nanowire, a germanium nanoparticle, a germanium nanotube, a germanium film, or a germanium substrate.

Hereinafter, an example in which the germanium structure is a germanium nanowire 100 will be described in detail.

For example, the germanium nanowire 100 may be synthesized using a vapor liquid solid (VLS) process.

Referring to FIG. 2B, a graphene layer 200 may be directly grown on a surface of the germanium nanowire 100 using a catalyst-free CVD process.

According to the present invention, the graphene layer 200 may be directly grown on the surface of the germanium nanowire 100 using the catalyst-free CVD process, thereby enabling coating of a high-quality layer.

In addition, by controlling the growth temperature of the graphene layer 200, the graphene layer 200 may include defects having disconnection points. Due to the defects, lithium ions may easily diffuse into the germanium nanowire 100, be input to/output from the germanium nanowire 100, and react with the germanium nanowire 100.

Meanwhile, in the present invention, a lithium secondary battery including a positive electrode, a negative electrode including a germanium structure and a graphene layer directly disposed on a surface of the germanium structure, and a lithium-salt electrolyte interposed between the positive electrode and the negative electrode, may be fabricated.

The germanium structure may be a germanium nanowire, a germanium nanoparticle, a germanium nanotube, a germanium film, or a germanium substrate. In this case, the graphene layer may be grown on a surface of the germanium structure using a catalyst-free growth process.

### Comparative Example

A germanium nanowire was synthesized by performing a VLS process at a temperature of about 760° C. using GeCl₄ as a liquid germanium (Ge) precursor.

Specifically, the germanium nanowire was synthesized by performing a VLS process using a Au nanoparticle catalyst by means of a liquid silicon tetrachloride (SiCl₄, 99.998%, Alfa Aesar) precursor and a liquid germanium tetrachloride (GeCl₄, 99.9999%, Alfa Aesar) precursor.

Initially, to form Au catalyst nanoparticles on a silicon (111) wafer, the silicon (111) wafer was dipped in a hydrogen fluoride (HF) solution for about 10 minutes, and then dipped in a HAuCl₄ water solution to form Au catalyst nanoparticles.

When a reaction temperature reached a temperature of about 760° C. while supplying argon (Ar) and hydrogen (H₂) at flow rates of about 180 sccm and about 30 sccm, respectively, to the silicon (111) wafer containing the Au nanoparticles, a reaction was caused for about 1 hour by simultaneously supplying SiCl₄ and GeCl₄ to synthesize a germanium nanowire.

### Fabrication Example A germanium nanowire having a surface on which a graphene layer was directly disposed was fabricated.

Initially, as in the above-described Comparative Example, a VLS process was performed using GeCl₄ as a liquid Ge precursor at a temperature of about 760° C. to synthesize the germanium nanowire.

Next, graphene was directly grown on the surface of the germanium nanowire synthesized using a catalyst-free CVD process.

Specifically, after synthesizing the germanium nanowire as in Comparative Example, a reactive gas was switched to CH₄ and H₂, and graphene was directly grown on the surface of the synthesized germanium nanowire. After synthesizing the germanium nanowire, this method included cooling the germanium nanowire to room temperature, disposing the germanium nanowire in the center of a new quartz tube, supplying H₂ until a reaction temperature reached a temperature of about 870° C., and supplying CH₄ as a reaction gas to directly grow graphene. In this case, a reaction was caused at a temperature of about 870° C. for about 2 hours by supplying CH₄ at a flow rate of about 50 sccm, and supplying H₂ at a flow rate of about 50 sccm to the germanium nanowire. Thus, a graphene layer was grown. Subsequently, the germanium nanowire having the surface on which the graphene layer was grown was cooled under H₂ conditions.

### Experimental Example

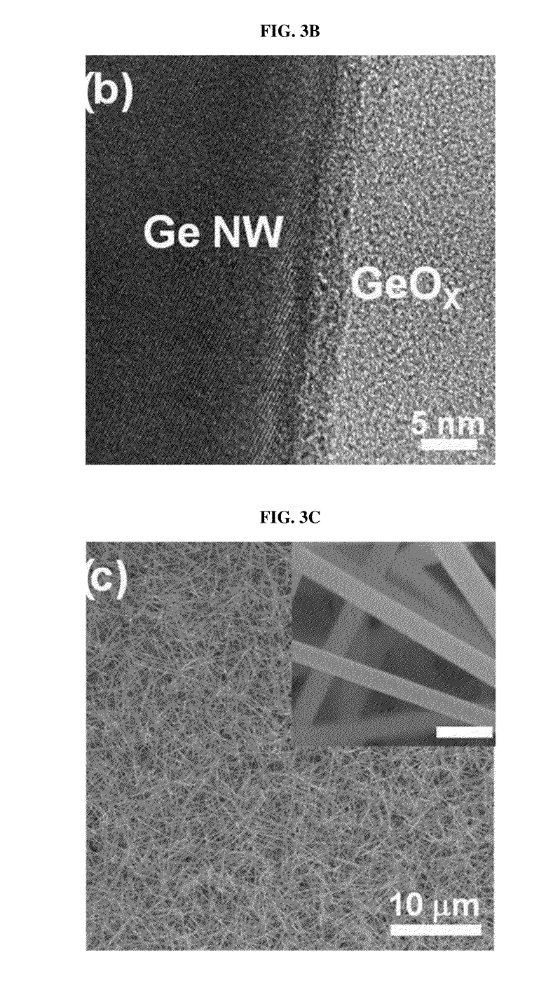

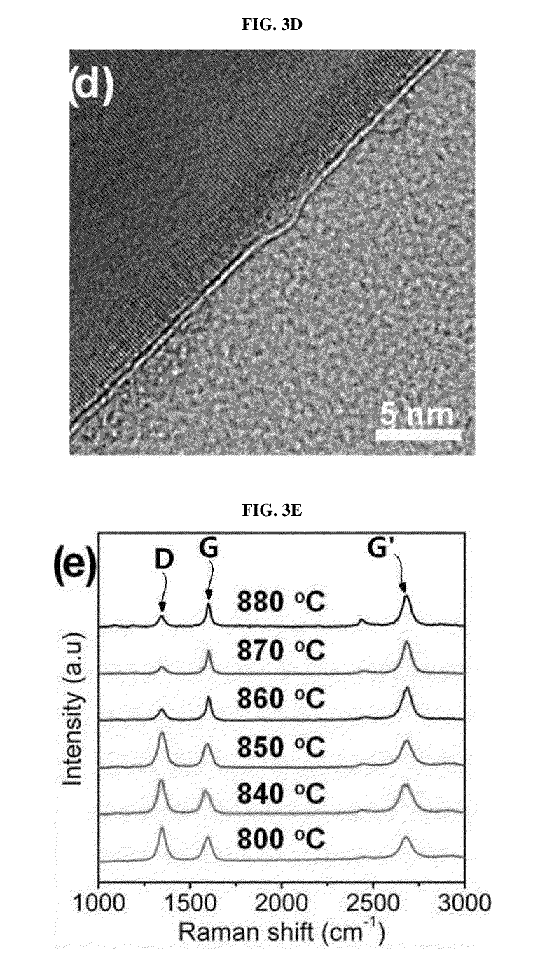

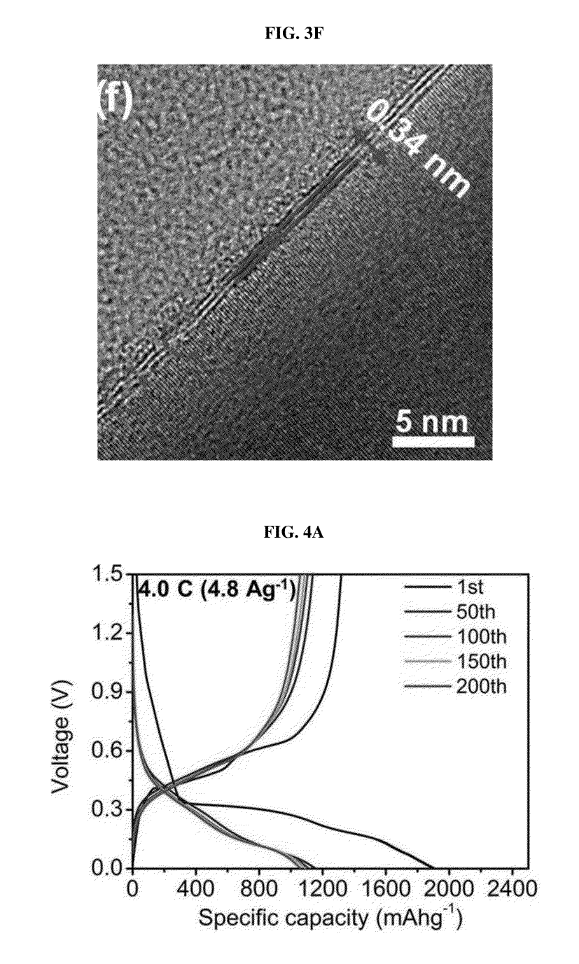

FIGS. 3A through 3F are scanning electron microscope (SEM) and transmission electron microscopes (TEM) images of a germanium nanowire and a germanium nanowire having a surface on which a graphene layer is directly disposed, and a graph.

FIGS. 3A and 3B are SEM and TEM images of germanium nanowires as grown. That is, FIGS. 3A and 3B are SEM and TEM images of the germanium nanowire according to Comparative Example. In this case, scale bars in an image inserted in FIG. 3A are about 200 nm.

Referring to FIGS. 3B, it can be seen that a germanium oxide (GeOₓ) layer, which was a native oxide layer, was formed on the surface of the germanium nanowire.

FIGS. 3D, and 3F are SEM and TEM images of germanium nanowires having surfaces on which a graphene layer was directly disposed. That is, FIGS. 3C, 3D, and 3F are SEM and TEM images of the germanium nanowire fabricated according to Fabrication Example. In this case, scale bars in an image inserted in FIG. 3C are about 200 nm.

Referring to FIG. 3C, it can be seen that morphologies were properly maintained without structural damage.

Referring to FIG. 3D, a single graphene layer covering a germanium nanowire can be confirmed.

Referring to FIG. 3F, a double graphene layer covering a germanium nanowire can be confirmed. In this case, a distance between two layers constituting the double graphene layer is about 0.34 nm.

Meanwhile, from dotted circles illustrated in FIGS. 3D and 3F, it can be confirmed that the graphene layer included defects having disconnection points along a growth axis thereof.

That is, the graphene layer may be effectively mechanically held on the surface of the germanium nanowire so that volume expansion of the germanium nanowire can be minimized due to a high surface coverage of the graphene layer. Furthermore, defects of the graphene layer may aid lithium ions to diffuse into the germanium nanowire and be input/output to/from the germanium nanowire.

Meanwhile, FIG. 3E is a graph of Raman spectroscopy of a graphene layer relative to a growth temperature.

By observing peaks G and G′ from the graphene layer grown within the temperature range of about 800° C. to about 880° C., it can be confirmed that the graphene layer was formed on the surface of the germanium nanowire.

In addition, it can be seen that the quality of the graphene layer determined by the intensity of peak D (1346 cm⁻¹) associated with structural disorder, is greatly dependent on a growth temperature. In other words, it can be inferred that as the growth temperature increases, the intensity of peak D decreases. Accordingly, as the growth temperature increases, the quality of the graphene layer may be improved.

However, when the graphene layer is grown at a temperature higher than about 900° C., serious morphological destruction of the germanium nanowire was observed. Thus, an upper limit may be set on a growth temperature.

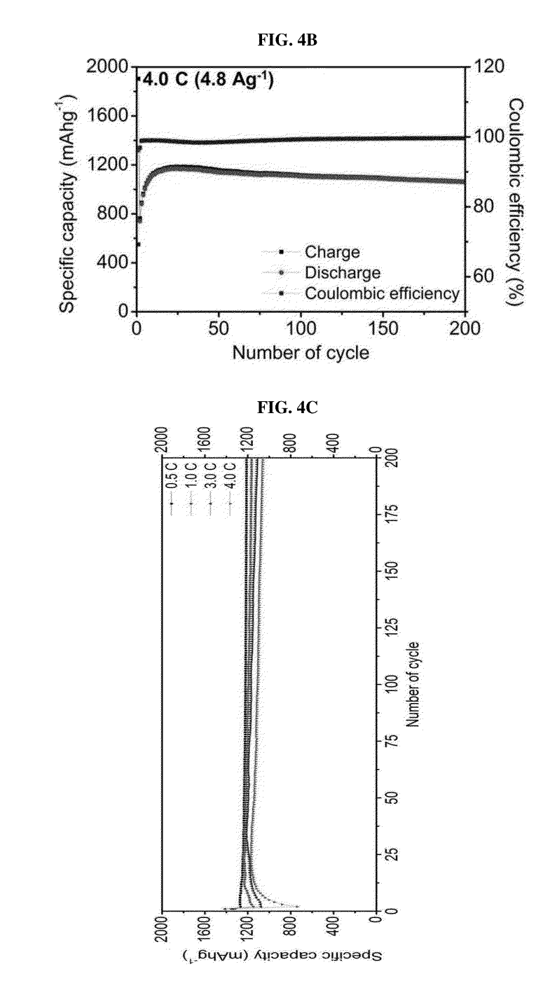

FIGS. 4A through 4C are graphs showing voltage profiles and cycling characteristics of a germanium nanowire having a surface on which graphene is directly disposed.

Results of FIGS. 4A through 4C were obtained by analyzing the characteristics of a germanium nanowire having a surface on which a graphene layer was directly disposed, according to Fabrication Example.

FIG. 4A is a graph showing a voltage profile of the germanium nanowire, which ranges from about 0.001 V to about 1.5 V at a charging/discharging rate of about 4.0V.

Referring to FIG. 4A, it can be seen that even if the number of times charging/discharging cycles are performed increases, a high specific capacity was maintained.

Accordingly, the germanium nanowire having the surface on which the graphene layer was directly disposed had a long cyclic life and a high capacity at a charging/discharging rate of about 4.0 C.

FIG. 4B is a graph showing a specific capacity and coulombic efficiency relative to the number of charging/discharging cycles.

Referring to FIG. 4B, even if the charging/discharging cycles were performed about 200 times, the germanium nanowire maintained about 90% (about 1059 mAhg⁻¹) the specific capacity, and stably exhibited a coulomic efficiency higher than about 98%. Accordingly, it can be seen that the germanium nanowire having the surface on which the graphene layer was directly disposed has good reversibility in terms of charging/discharging of lithium ions.

FIG. 4C is a graph showing a specific capacity relative to the number of cycles relative to a current rate (C-rate).

Referring to FIG. 4C, it can be seen that even if the C rate increased, a charge capacity was not greatly reduced, and the germanium nanowire maintained a stable capacity.

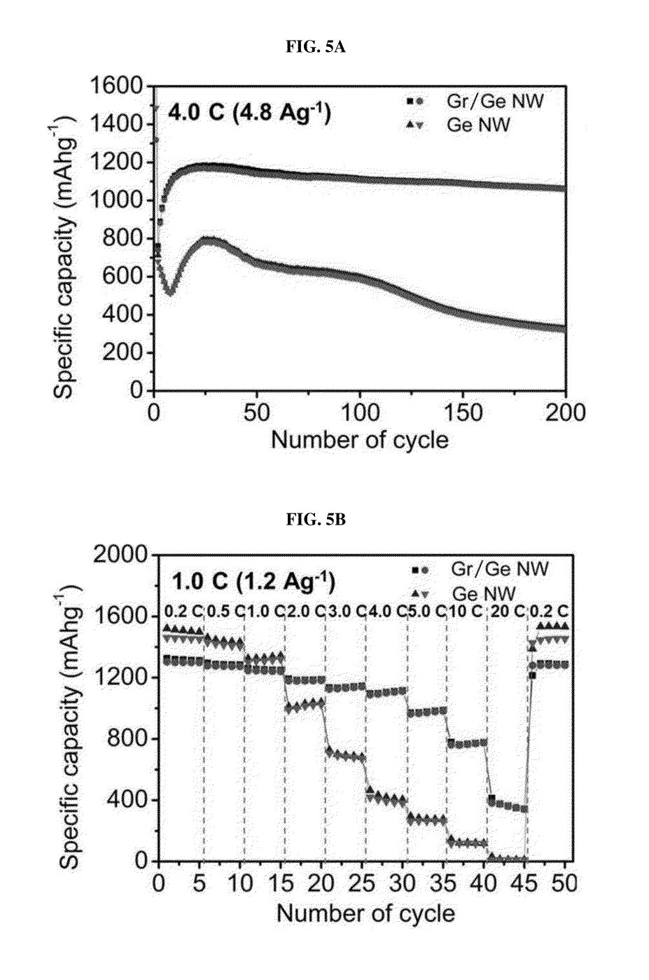

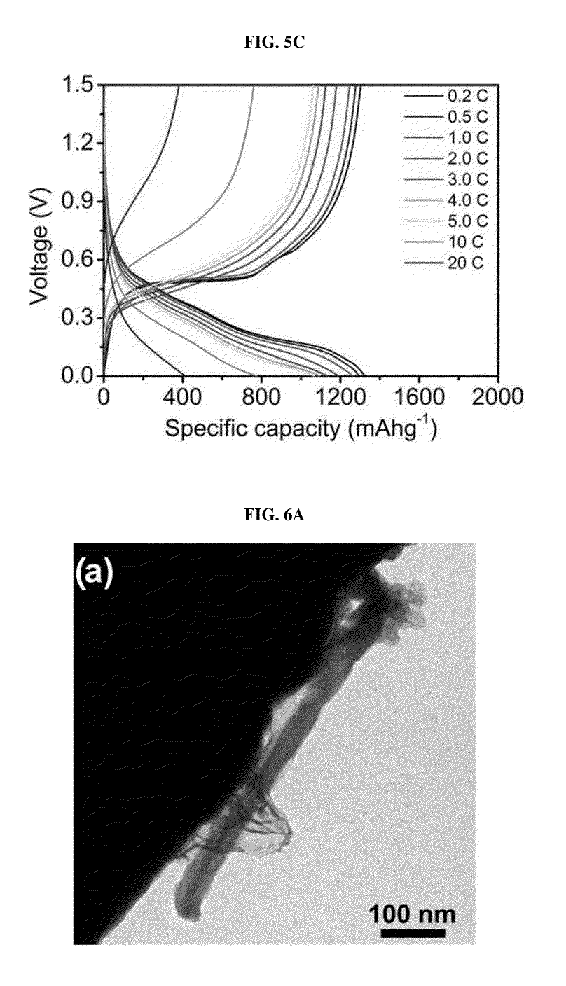

FIGS. 5A through 5C are graphs showing characteristics of a germanium nanowire and a germanium nanowire having a surface on which graphene is directly disposed.

FIGS. 5A and 5B are graphs of a specific capacity relative to the number of charging/discharging cycles of each of a germanium nanowire fabricated according to Comparative Example, and a Gr/Ge nanowire having a surface on which a graphene layer was directly disposed according to Fabrication Example.

FIG. 5C is a graph showing a voltage profile corresponding to a rate capability of a germanium nanowire having a surface on which a graphene layer was directly disposed according to Fabrication Example, which is measured in FIG. 5B.

Referring to FIG. 5A, after the charging/discharging cycles were performed 200 times, the germanium nanowire fabricated according to Comparative Example exhibited a very low capacity of about 321 mAhg⁻¹ and a low capacity retention of about 41%.

In contrast, even if the number of the charging/discharging cycles increased, the Gr/Ge nanowire having the surface on which the graphene layer was directly disposed maintained a stable capacity.

Referring to FIGS. 5B and 5C, when the number of charging/discharging cycles was increased while increasing a charging/discharge rate from 0.2 C to 20 C, the Gr/Ge nanowire having the surface on which the graphene layer was directly disposed maintained a specific capacity far more effectively than the germanium nanowire fabricated according to Comparative Example.

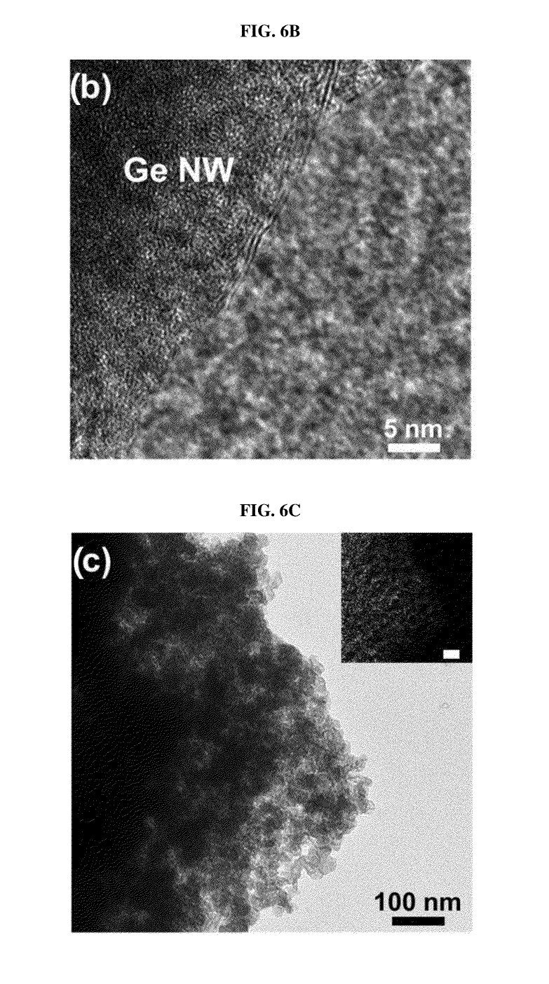

FIGS. 6A through 6C are TEM images of a germanium nanowire and a germanium nanowire having a surface on which graphene is directly disposed, after performing a charging/discharging cycle.

After the charging/discharging cycles were performed about 200 times at a charging/discharging rate of about 4.0 C, TEM images of the germanium nanowire according to Comparative Example, and the Gr/Ge nanowire having the surface on which graphene was directly disposed according to Fabrication Example, were measured.

FIGS. 6A and 6B are TEM images of a germanium nanowire having a surface on which graphene was directly disposed according to Fabrication Example after charging/discharging cycles were performed about 200 times at a charging/discharging rate of about 4.0 C.

Referring to FIGS. 6A and 6B, it can be seen that even if the charging/discharging cycles were performed about 200 times, the germanium nanowire was successfully protected by a graphene layer. Accordingly, volume expansion of the germanium nanowire may be prevented and minimized by the graphene layer during the charging/discharging cycles.

FIG. 6C is a TEM image of a germanium nanowire according to Comparative Example after charging/discharging cycles were performed about 200 times at a charging/discharging rate of about 4.0 C. In this case, scale bars in an image inserted in FIG. 6C, which is an image obtained by mapping a Ge element using electron energy-loss spectroscopy (EELS), are about 100 nm.

Referring to FIG. 6C, it can be seen that the germanium nanowire having the surface on which a graphene layer was not coated, was rapidly pulverized.

Accordingly, volume expansion of the germanium nanowire may be minimized by the graphene layer during the charging/discharging cycle.

According to the present invention, a graphene layer can be directly disposed on the surface of a germanium structure so that volume expansion of the germanium structure can be minimized during cycles of alloying/dealloying reactions with lithium.

Also, the graphene layer can include a single layer or a small number of layers and include an appropriate amount of defects so that lithium ions can easily diffuse into the germanium structure, be input/output to/from the germanium structure, and react with the germanium structure.

Furthermore, graphene may be directly grown on the surface of the Ge structure using a catalyst-free CVD process, thereby enabling coating of a high-quality layer.

Aspects of the inventive concept should not be limited by the above description, and other unmentioned aspects will be clearly understood by one of ordinary skill in the art from example embodiments described herein.

While the example embodiments of the present invention and their advantages have been described in detail, it should be understood that various changes, substitutions and alterations may be made herein without departing from the scope of the invention.

What is claimed is:

1. A negative electrode for a lithium secondary battery, comprising:
a germanium (Ge) structure; and
a graphene layer directly disposed on a surface of the germanium structure,
wherein the graphene layer is grown on the surface of the germanium structure using a catalyst-free growth process.

2. A negative electrode for a lithium secondary battery, comprising:
a germanium structure; and
a graphene layer directly disposed on a surface of the germanium structure,
wherein the number of graphene layers ranges from 1 to 6.

3. The negative electrode of any one of claims 1 and 2,
wherein the germanium structure includes a germanium nanowire (Ge NW), a germanium nanoparticle (Ge NP), a germanium nanotube (Ge NT), a germanium film, or a germanium substrate.

4. The negative electrode of any one of claims 1 and 2, wherein the graphene layer includes defects having disconnection points along a growth axis to allow lithium ions to diffuse into the germanium nanostructure.

5. A method of fabricating a negative electrode for a lithium secondary battery, the method comprising:
preparing a germanium structure; and
directly growing a graphene layer on a surface of the germanium structure using a catalyst-free chemical vapor deposition (CVD) process.

6. The method of claim 5, wherein the germanium structure includes a germanium nanowire, a germanium nanoparticle, a germanium nanotube, a germanium film, or a germanium substrate.

7. A lithium secondary battery comprising:
a positive electrode;
a negative electrode including a germanium nanostructure and a graphene layer directly disposed on a surface of the germanium nanostructure; and
a lithium-salt electrolyte interposed between the positive electrode and the negative electrode.

8. The lithium secondary battery of claim 7, wherein the graphene layer is grown on the surface of the germanium structure using a catalyst-free growth process.
